(19) United States
(12) Patent Application Publication
(10) Pub. No.: US 2020/0135142 A1
(43) Pub. Date: Apr. 30, 2020

(54) Method and System for Calibrating One or More Display Settings

(71) Applicant: CenturyLink Intellectual Property LLC, Broomfield, CO (US)

(72) Inventors: Zubin Ingah, Centennial, CO (US); Michael D. Sprenger, Boulder, CO (US)

(21) Appl. No.: 16/171,009

(22) Filed: Oct. 25, 2018

(51) Int. Cl. G09G 5/10; G09G 5/04

(52) U.S. Cl. CPC G09G 5/10; G09G 5/04; G09G 2360/144; G09G 2320/066; G09G 2320/0693; G09G 2320/0666; G09G 2354/00; G09G 2320/0606; G09G 2320/0626

(57) ABSTRACT

Novel tools and techniques are provided for implementing display settings on customer premises equipment (“CPE”), and, more particularly, for implementing, calibrating, and adjusting display settings on one or more display devices. In operation, a CPE might detect at least one of an amount of ambient light, a time of day, a time of year, a type of environment, or input from one or more sensors detecting the display screen of the display device or the amount of ambient light where the display screen operates. The CPE might adjust one or more display settings based at least in part on the at least one of the amount of ambient light, the time of day, the time of year, the type of environment, or the input from the one or more sensors detecting the display screen of the media display device or the amount of ambient light where the display screen operates.

### CROSS-REFERENCES TO RELATED APPLICATIONS

This application may be related to U.S. patent application Ser. No. 16/109,216 (the “'216 Application”), filed on Aug. 22, 2018 by Zubin Ingah et al. (attorney docket no. 1489-US-U1), entitled, “Method and System for Restoring Configuration Settings of Customer Premises Equipment,” which claims priority to U.S. Patent Application Ser. No. 62/582,158 (the “'158 Application”), filed on Nov. 6, 2017 by Michael D. Sprenger et al. (attorney docket no. 1489-US-P1), entitled, “Novel Method for Storage and Restoration of Customer Premises Equipment (CPE) Configuration Data,” the disclosure of which is incorporated herein by reference in its entirety for all purposes.

The respective disclosures of these applications/patents (which this document refers to collectively as the “Related Applications”) are incorporated herein by reference in their entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing display settings on customer premises equipment (“CPE”), and, more particularly, to methods, systems, and apparatuses for implementing, calibrating, and/or adjusting display settings on one or more display devices and/or on one or more CPEs.

### BACKGROUND

Currently, the configuration of display settings on customer premises equipment (“CPE”) and/or display devices requires manual setup and manual entry of one or more display settings. The display settings of one or more CPE and/or display devices do not adjust automatically (i.e., without user input). Additionally, if the one or more CPE and/or display devices need to be replaced or upgraded, customers generally have to manually reenter the one or more display settings on the new or upgraded CPE and/or display devices, which can be a tedious process. Furthermore, given that ambient light levels and light quality can change, it is desirable to have a mechanism that can automatically adjust display settings in response to such changes. Current state of the art technology enables automatic brightness adjustment for TVs. However, established technology relies on sensors and control mechanisms to be built into the TV or display.

Hence, there is a need for more robust and scalable solutions for implementing display settings on customer premises equipment (“CPE”), and, more particularly, to methods, systems, and apparatuses for implementing, calibrating, and/or adjusting display settings on one or more display devices and/or on one or more CPEs.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a schematic diagram illustrating a system for implementing, calibrating, and/or adjusting display settings on one or more display devices and/or on one or more customer premises equipment, in accordance with various embodiments.

FIG. 2 is a schematic diagram illustrating another system for implementing, calibrating, and/or adjusting display settings on one or more display devices and/or on one or more customer premises equipment, in accordance with various embodiments.

FIG. 3 is a schematic diagram illustrating yet another system for implementing, calibrating, and/or adjusting display settings on one or more display devices and/or on one or more customer premises equipment, in accordance with various embodiments.

FIG. 4 is a flow diagram illustrating a method for implementing, calibrating, and/or adjusting display settings on one or more display devices and/or on one or more customer premises equipment, in accordance with various embodiments.

FIG. 5 is a block diagram illustrating an exemplary computer or system hardware architecture, in accordance with various embodiments.

FIG. 6 is a block diagram illustrating a networked system of computers, computing systems, or system hardware architecture, which can be used in accordance with various embodiments.

### DETAILED DESCRIPTION OF CERTAIN EMBODIMENTS

Overview

Various embodiments provide tools and techniques for implementing display settings on customer premises equipment (“CPE”), and, more particularly, to methods, systems, and apparatuses for implementing, calibrating, and/or adjusting display settings on one or more display devices and/or on one or more CPEs.

The methods, systems, and apparatuses described herein enable a wider range of adjustments of display settings and do not require dedicated hardware included in the TV or display. The methods, systems, and apparatuses described herein rely on existing devices at the user's premises and on software residing in the user's TV and/or CPE. These new methods, systems, and apparatuses go beyond simple brightness adjustments and also enables adjustments such as color balance, contrast, and/or the like, in response to ambient light changes.

In various embodiments, a method might include detecting, with a media display device, a remote control, a mobile device, a tablet, and/or other standalone devices, and/or the like (collectively, “a media display device” or the like), at least one of an amount of ambient light within a room, a time of day, a time of year, a type of environment within the room, or input from one or more sensors detecting a display screen of the media display device and/or detecting the ambient light level where the display screen of the media display device operates and adjusting, with the media display device, one or more display settings based at least in part on the at least one of the amount of ambient light within the room, the time of day, the time of year, the type of environment within the room, or the input from the one or more sensors detecting the display screen of the media display device and/or detecting the ambient light level where the display screen of the media display device operates.

The one or more display settings may include, without limitation, one or more brightness settings, one or more color settings, or one or more contrast settings, and/or the like.

In sum, the various embodiments provide methods, systems, and apparatuses to adjust and calibrate display settings associated with a user or a customer premises with little or no user intervention. Further, the various embodiments provide ways to automatically reconfigure a first customer premises device or automatically configure a second customer premises device with display settings associated with the user or the customer premises.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Various embodiments described herein, while embodying (in some cases) software products, computer-performed methods, and/or computer systems, represent tangible, concrete improvements to existing technological areas, including, without limitation, CPE technology, display technology, and/or the like. In other aspects, certain embodiments can improve the functioning of a CPE (e.g., a set-top box, a gateway, a media player, a display device, and/or the like), for example, by detecting, with a media display device, a remote control, a mobile device, a tablet, and/or other standalone devices, and/or the like (collectively, “a media display device” or the like), at least one of an amount of ambient light within a room, a time of day, a time of year, a type of environment within the room, or input from one or more sensors detecting a display screen of the media display device and/or detecting the ambient light level where the display screen of the media display device operates; and adjusting, with the media display device and optionally the CPE, one or more display settings based at least in part on the at least one of the amount of ambient light within the room, the time of day, the time of year, the type of environment within the room, or the input from the one or more sensors detecting the display screen of the media display device and/or detecting the ambient light level where the display screen of the media display device operates; and/or the like. In particular, to the extent any abstract concepts are present in the various embodiments, those concepts can be implemented as described herein by devices, software, systems, and methods that involve specific novel functionality (e.g., steps or operations), such as, detecting, with a media display device, a remote control, a mobile device, a tablet, and/or other standalone devices, and/or the like (collectively, “a media display device” or the like), at least one of an amount of ambient light within a room, a time of day, a time of year, a type of environment within the room, or input from one or more sensors detecting a display screen of the media display device and/or detecting the ambient light level where the display screen of the media display device operates; and adjusting, with the media display device, one or more display settings based at least in part on the at least one of the amount of ambient light within the room, the time of day, the time of year, the type of environment within the room, or the input from the one or more sensors detecting the display screen of the media display device and/or detecting the ambient light level where the display screen of the media display device operates, and/or the like, which optimizes the replacement of a customer premises device or reconfiguration of a customer premises device, the storage of display settings, the configuration of display settings, the adjustment of display settings, and/or the like, to name a few examples, that extend beyond mere conventional computer processing operations. These functionalities can produce tangible results outside of the implementing computer system, including, merely by way of example, optimizing the replacement of a customer premises device or reconfiguration of a customer premises device, the storage of display settings, the configuration of display settings, the adjustment of display settings, and/or the like.

In an aspect, a method might comprise detecting, with a media display device, a remote control, a mobile device, a tablet, and/or other standalone devices, and/or the like (collectively, “a media display device” or the like), at least one of an amount of ambient light within a room, a time of day, a time of year, a type of environment within the room, or input from one or more sensors detecting a display screen of the media display device and/or detecting the ambient light level (or an amount of ambient light) where the display screen of the media display device operates and adjusting, with the media display device, one or more display settings based at least in part on the at least one of the amount of ambient light within the room, the time of day, the time of year, the type of environment within the room, or the input from the one or more sensors detecting the display screen of the media display device and/or detecting the ambient light level (or the amount of ambient light) where the display screen of the media display device operates.

In various embodiments, the media display device, might include, without limitation, at least one of a television, a laptop computer, a tablet computer, a smart phone, or a mobile phone, and/or the like. The display settings might include, without limitation, one or more brightness settings, one or more color settings, or one or more contrast settings, and/or the like.

In some embodiments, the ambient light within the room may be detected using an ambient light sensor. The ambient light sensor may be incorporated in at least one of the media display device, a set-top box, or a user device, and/or the like.

According to some embodiments, the type of environment within the room includes, without limitation, at least one of a position of one or more curtains within the room, a number of lights turned on within the room, or a type of weather occurring outside the room, and/or the like.

Merely by way of example, in some embodiments, the one or more sensors detecting the display screen of the media display device and/or detecting the ambient light level where the display screen of the media display device operates may comprise one or more colorimeter sensors, one or more cameras, one or more light sensors, and/or the like. The media display device may determine one or more display settings to adjust based at least in part on input from the one or more colorimeter sensors or the one or more cameras.

In some embodiments, the method might further comprise associating, with the media display device, one or more adjusted display settings with at least one of the amount of ambient light within the room, the time of day, the time of year, or the type of environment within the room and saving, with the media display device, the one or more adjusted display settings associated with the at least one of the amount of ambient light within the room, the time of day, the time of year, or the type of environment within the room.

In additional embodiments, the method might include determining, with the media display device, whether the one or more display settings should be adjusted based at least in part on at least one of the amount of ambient light within the room, the time of day, the time of year, or the type of environment within the room and adjusting, with the media display device, the one or more display settings to one or more saved adjusted display settings based on a determination that the one or more display settings should be adjusted.

In some cases, the one or more display settings may be configured by a user of the media display device. The media device may prompt a user to set one or more display settings and associate the one or more display settings with at least one of the amount of ambient light within the room, the time of day, the time of year, or the type of environment within the room.

In various embodiments, the method might further include determining, with the media display device, whether one or more adjusted display settings have been associated with the at least one of the amount of ambient light within the room, the time of day, the time of year, or the type of environment within the room. Based on a determination that the one or more adjusted display settings have been associated with the at least one of the amount of ambient light within the room, the time of day, the time of year, or the type of environment within the room, the method might include adjusting, with the media display device, the one or more display settings based at least in part on the at least one of the amount of ambient light within the room, the time of day, the time of year, or the type of environment within the room. Based on a determination that the one or more adjusted display settings have not been associated with the at least one of the amount of ambient light within the room, the time of day, the time of year, or the type of environment within the room, the method might include prompting, a user to set one or more display settings associated with at least one of the amount of ambient light within the room, the time of day, the time of year, or the type of environment within the room.

In another aspect, an apparatus might comprise at least one processor; and a non-transitory computer readable medium communicatively coupled to the at least one processor. The non-transitory computer readable medium might have stored thereon computer software comprising a set of instructions that, when executed by the at least one processor, causes the apparatus to: detect at least one of an amount of ambient light within a room, a time of day, a time of year, a type of environment within the room, or input from one or more sensors detecting at least one of a display screen of a media display device or the amount of ambient light where the display screen of the media display device operates; and adjust one or more display settings based at least in part on the at least one of the amount of ambient light within the room, the time of day, the time of year, the type of environment within the room, or the input from the one or more sensors detecting at least one of the display screen of the media display device and/or detecting the ambient light level (or the amount of ambient light) where the display screen of the media display device operates.

According to some embodiments, the one or more display settings might include one or more brightness settings, one or more color settings, or one or more contrast settings, and/or the like.

In various embodiments, the ambient light within the room may be detected using an ambient light sensor. The environment may include, without limitation, at least one of a position of one or more curtains within the room, a number of lights turned on within the room, or a type of weather occurring outside the room, and/or the like. The one or more sensors detecting at least one of the display screen of the media display device and/or detecting the ambient light level (or the amount of ambient light) where the display screen of the media display device operates may comprise one or more colorimeter sensors, one or more cameras, one or more light sensors, and/or the like.

In yet another aspect, a system might comprise a first media display device. The first display device might comprise at least one first processor and a first non-transitory computer readable medium communicatively coupled to the at least one first processor. The first non-transitory computer readable medium might have stored thereon computer software comprising a first set of instructions that, when executed by the at least one first processor, causes the first display device to: detect at least one of an amount of ambient light within a room, a time of day, a time of year, a type of environment within the room, or input from one or more sensors detecting a display screen of a media display device and/or detecting the ambient light level where the display screen of the media display device operates; and adjust one or more display settings based at least in part on the at least one of the amount of ambient light within the room, the time of day, the time of year, the type of environment within the room, or the input from the one or more sensors detecting the display screen of the media display device and/or detecting the ambient light level where the display screen of the media display device operates.

The system might additionally include one or more sensors. The one or more sensors might comprise at least one second processor and a second non-transitory computer readable medium communicatively coupled to the at least one second processor. The second non-transitory computer readable medium might have stored thereon computer software comprising a second set of instructions that, when executed by the at least one second processor, causes the one or more sensors to: detect at least one of the amount of ambient light within the room, the type of environment within the room, or the display screen of the media display device; and send information associated with at least one of the amount of ambient light within the room, the type of environment within the room, or the display screen of the media display device to the media display device.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### Specific Exemplary Embodiments

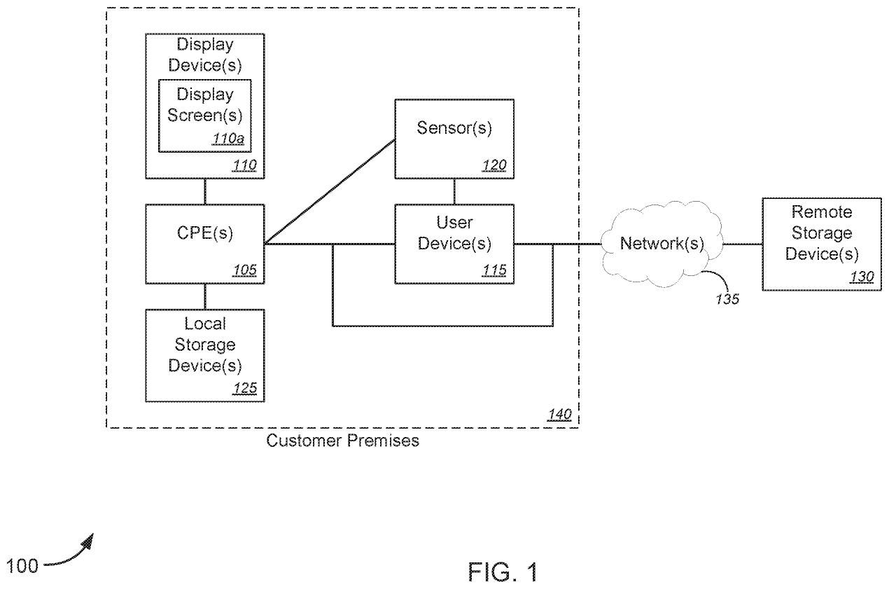

We now turn to the embodiments as illustrated by the drawings. FIGS. 1-6 illustrate some of the features of the method, system, and apparatus for implementing display settings on customer premises equipment (“CPE”), and, more particularly, to methods, systems, and apparatuses for implementing, calibrating, and/or adjusting display settings on one or more display devices and/or on one or more CPEs. The methods, systems, and apparatuses illustrated by FIGS. 1-6 refer to examples of different embodiments that include various components and steps, which can be considered alternatives or which can be used in conjunction with one another in the various embodiments. The description of the illustrated methods, systems, and apparatuses shown in FIGS. 1-6 is provided for purposes of illustration and should not be considered to limit the scope of the different embodiments.

With reference to the figures, FIG. 1 is a schematic diagram illustrating a system 100 for implementing, calibrating, and/or adjusting display settings on one or more display devices and/or on one or more customer premises equipment (“CPEs”) 105, in accordance with various embodiments.

In the non-limiting embodiment of FIG. 1, system 100 might include one or more CPEs (or one or more customer premises devices) 105 and/or one or more display devices 110 (which might include one or more display screens 110a). The system 100 might additionally include one or more user devices 115 and/or one or more sensors 120. System 100 might also include a local storage device(s) 125 and/or a remote storage device(s) 130.

In some embodiments, the CPE(s) 105 might include, but is not limited to, one of a set-top box (“STB”), a media player, a gaming console, a desktop computer, a laptop computer, a tablet computer, a mobile device, or a smartphone, and/or the like.

The one or more display devices 110 (with one or more display screens 110a) might include, without limitation, at least one of a television, a gaming console (with display screen), a laptop computer, a tablet device, a mobile device, a smart phone, a laptop computer, a tablet device (with touchscreen display), a smart phone, a mobile phone, or a laptop computer, and/or the like.

In some embodiments, the one or more user device(s) 115 might each include, without limitation, one of a laptop computer, a tablet computer, a desktop computer, a smart phone, a mobile phone, a personal digital assistant, a remote-control device, a gaming console, a set-top box, a media player, a portable gaming device, a camera, or a sensor, and/or the like.

The one or more sensors 120 might include, without limitation, at least one of one or more ambient light sensor(s), one or more colorimeter sensor(s), one or more cameras, one or more weather sensors, or one or more window covering sensor(s), and/or the like.

The local storage device(s) 125 and/or the remote storage device(s) 130 might each include, but is not limited to, a Flash drive(s), Electrically Erasable Programmable Random-Access Memory (EEPROM), a hard disk drive(s), or any other suitable storage technology, and/or the like. The local storage device(s) 125 and/or the remote storage device(s) 130 might be used to store one or more display settings or updated display settings associated with CPE(s) 105 and/or display device 110 (or its display screen 110a). The one or more display settings stored in local storage device(s) 125 and/or remote storage device(s) 130 might be transferred between one or more CPEs as outlined and described in detail in the '216 Application (which has already been incorporated herein by reference in its entirety for all purposes).

The CPE(s) 105 might communicatively couple to each of the one or more devices 110, the display screens 110a of the display devices 110, the one or more user devices 115, the one or more sensors 120, the local storage device(s) 125, and/or the remote storage device(s) 130, and/or the like, via a wireless connection and/or a wired connection. Each of the one or more user devices 115 might communicatively couple to the one or more sensors 120, the local storage device(s) 125, and/or remote storage device(s) 130 either via wireless connection and/or via wired connection. Additionally and/or alternatively, CPE(s) 105 and/or user devices 115 might be communicatively coupled to the remote storage device(s) 130 via one or more network(s) 135.

In some cases, the CPE(s) 105 might be paired, synced, or synchronized with the one or more display devices 110, the one or more user devices 115, the one or more sensors 120, the local storage device(s) 125, and/or the remote storage device(s) 130, or the like. In some instances, the user device(s) 115 might be paired, synced, or synchronized with the CPE(s) 105, the one or more display devices 110, the one or more sensors 120, the local storage device(s) 125, and/or the remote storage device(s) 130, or the like.

In some cases, the one or more sensors 120 and/or the local storage device(s) 125 might be integrated with the CPE(s) 105, the one or more display devices 110, or the one or more user devices 115, and/or the like. Additionally and/or alternatively, the one or more sensors 120 and/or the local storage device(s) 125 might be separate from the CPE(s) 105, the one or more display devices 110, or the one or more user devices 115, and/or the like. The one or more sensors 120 may be one or more pluggable external devices that are capable of being plugged into at least one of CPE(s) 105 and/or user device(s) 115.

In some cases, the CPE(s) 105, the one or more display devices 110, the one or more user device(s) 115, the one or more sensors 120, and/or the local storage device(s) 125, or the like, may be disposed within a customer premises 140, which might be one of a single family house, a multi-dwelling unit (“MDU”) within a multi-dwelling complex (including, but not limited to, an apartment building, an apartment complex, a condominium complex, a townhouse complex, or a mixed-use building, etc.), a motel, an inn, a hotel, an office building or complex, a commercial building or complex, or an industrial building or complex, and/or the like.

In operation, the CPE(s) 105 and/or display device(s) 110 might receive, set, or include one or more display settings (e.g., one or more brightness settings, one or more color settings, one or more contrast settings, and/or the like). The one or more display settings may be default settings set by a manufacturer, one or more user configured display settings set by a user or technician, and/or one or more optimal display settings determined by one or more sensors 120 detecting a display screen 110a of the display device(s) 110 and/or of the CPE(s) 105, and/or the like. The one or more display settings may be set manually by a user of the CPE(s) 105 and/or display device(s) 110, may be set manually by a technician setting up or servicing CPE(s) 105 and/or display device(s) 110, or may be automatically set by at least one of the CPE(s) 105, and/or display device(s) 110, the user device(s) 115, or the sensors 120, and/or the like.

Next, the CPE(s) 105, and/or display device(s) 110, the user device(s) 115, and/or the one or more sensors 120 might detect at least one of an amount of ambient light within a room, a time of day, a time of year, a type of environment within the room, input from one or more sensors 120 detecting a display screen 110a of the CPE(s) 105, and/or display device(s) 110, or input from one or more sensors 120 detecting a type of environment within the room, and/or the like. The one or more sensors 120 may be incorporated in the CPE(s) 105, the display device(s) 110, the user device(s) 115, a remote control, a mobile device, a tablet, and/or the like. Additionally and/or alternatively, the one or more sensors 120 might be standalone devices.

The one or more sensors 120 may be communicatively coupled to CPE(s) 105 and/or display device(s) 110 to provide feedback including feedback associated with at least one of an amount of ambient light within a room, a time of day, a time of year, a type of environment within the room, and/or the like.

A time of day might include, without limitation, at least one of a morning, an afternoon, an evening, a sunset, a sunrise, an hour of the day, a specific hour and minute of the day, a specific hour, minute, and second of the day, and/or the like. A time of year might include, but is not limited to, at least one of a season (e.g., summer, fall, winter, or spring), a month, a week, a day, and/or the like. A type of environment might include, without limitation, at least one of a position of one or more curtains within the room, a number of lights turned on within the room, or a type of weather (e.g., sunny, cloudy, raining, snowing, etc.) occurring outside the room, and/or the like.

One or more sensors 120 may also be used to detect a display screen 110a of display device(s) 110 and/or of CPE(s) 105. These sensors 120 may include, without limitation, at least one of a colorimeter sensor or a camera directed toward a display screen 110a of display device(s) 110 or of CPE(s) 105. These sensors 120 may be used to automatically determine one or more optimal display screens 110a of display device 110 or of CPE 105.

One or more sensors 120 may additionally be used to detect an environment within a room. These sensors 120 may include one or more weather sensors, one or more window covering sensors, one or more ambient light sensors, and/or the like.

The CPE(s) 105, display device(s) 110, and/or the user device(s) 115 may then adjust one or more display settings associated with display screen 110a based at least in part on the at least one of the amount of ambient light within the room, the time of day, the time of year, the type of environment within the room, or the input from the one or more sensors detecting the display screen 110a of the CPE(s) 105 and/or display device(s) 110, and/or the like. Additionally and/or alternatively, the CPE(s) 105, display device(s) 110, and/or user device(s) 115 may adjust one or more display settings associated with display screen 110a based at least in part on feedback from the one or more sensors including feedback associated with at least one of an amount of ambient light within a room, a time of day, a time of year, or a type of environment within the room, and/or the like.

The one or more adjusted display settings may be stored in local storage device(s) 125 and/or remote storage device(s) 130 and associated with at least one of the amount of ambient light within the room, the time of day, the time of year, the type of environment within the room, or the input from the one or more sensors detecting the display screen of the media display device and/or detecting the ambient light level where the display screen of the media display device operates, and/or the like.

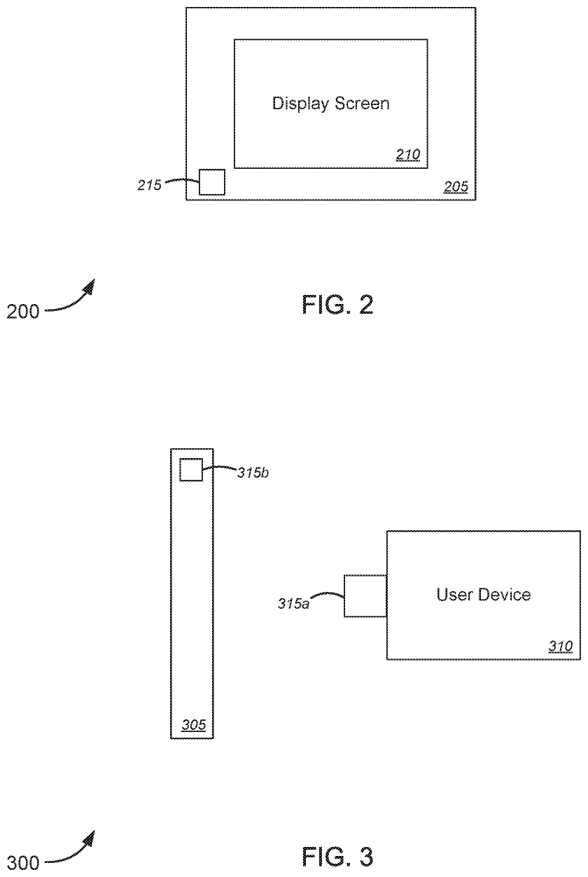

FIG. 2 is a schematic diagram illustrating a system 200 for implementing, calibrating, and/or adjusting display settings on one or more display devices and/or on one or more customer premises equipment (“CPEs”) 205.

System 200 includes customer premises equipment or display device 205 (which may correspond to CPE(s) 105 or display device(s) 110 of FIG. 1, or the like) with a display screen 210 (which may correspond to display screen 110a of FIG. 1, or the like) and one or more sensors 215 (which may correspond to sensor(s) 120 of FIG. 1, or the like). The one or more sensors 215 may be integrated in CPE or display device 205. Additionally and/or alternatively, the one or more sensors 215 may be pluggable external devices commutatively coupled to CPE or display device 205 via a wired and/or wireless (e.g., Bluetooth, WiFi, etc.) connection. The one or more sensors 215 may also be incorporated in a user device, remote control, mobile device, tablet, and/or the like.

In operation, the CPE or display device 205 may be programmed with different display settings (e.g., one or more brightness settings, one or more color settings, or one or more contrast settings, and/or the like) associated with at least one of the amount of ambient light within the room, the time of day, the time of year, or the type of environment within the room, and/or the like.

The one or more display settings may be preprogrammed by a CPE or display device 205 manufacturer, and/or the like. Additionally and/or alternatively, a user may configure the one or more display settings. Alternatively, or additionally, CPE or display device 205 may prompt a user to configure the one or more display settings and may associate the one or more display settings with at least one of the amount of ambient light within the room, the time of day, the time of year, or the type of environment within the room, and/or the like. The prompt may be displayed on display screen 210 or on a user device communicatively coupled to the CPE or display device 205, and/or the like.

The CPE or display device 205 might prompt the user to configure the one or more display settings when the CPE or display device 205 determines that the user has not configured one or more display settings associated with a particular amount of ambient light within the room, the time of day, the time of year, or the type of environment within the room, and/or the like. In a non-limiting example, CPE or display device 205 might determine that a user has not set one or more display settings associated with a time of day (e.g., 12:00 pm, or the like). If the CPE or display device 205 determines that a user is viewing display screen 210 at 12:00 pm, the CPE or display device 205 may prompt a user to set one or more preferred display settings and may associate those settings with the time of day (i.e., 12:00 pm.).

In some cases, the CPE or display device 205 may then save or store the preprogrammed settings and/or the one or more user configured display settings associated with a particular amount of ambient light within the room, the time of day, the time of year, or the type of environment within the room, and/or the like in a local or remote storage device(s).

Next, the CPE or display device 205 and/or the one or more sensors 215 may be configured to detect at least one of the amount of ambient light within the room, the time of day, the time of year, or the type of environment within the room, and/or the like and to retrieve one or more display settings associated with the detected amount of ambient light within the room, the time of day, the time of year, or the type of environment within the room, and/or the like from a local or remote storage device(s). CPE or display device 205 may then adjust the one or more display settings based at least in part on the one or more retrieved display settings.

The one or more adjusted display settings associated with the amount of ambient light within the room, the time of day, the time of year, or the type of environment within the room, and/or the like, may be associated with one or more pre-programmed display settings of the CPE. Alternatively, the one or more adjusted display settings may be associated with one or more user-configured display settings.

In a non-limiting example, if the CPE or display device 205 determines that the time of day is 12:00 pm, then the display screen may be adjusted to be brighter (e.g., to counter the natural daylight, or the like) based on one or more pre-programmed display settings and/or user configured display settings. If the CPE or display device 205 determines that the time of day is 11:00 pm, then the display screen might be dimmer (e.g., to prevent blinding a user due to the user's acclimatization to the lower or non-existent natural light at night, or the like) based on one or more pre-programmed display settings and/or user-configured display settings.

In some cases, the one or more display settings of the CPE or display device 205 may be adjusted based on two or more of the amount of ambient light within the room, the time of day, the time of year, or the type of environment within the room, and/or the like. In a non-limiting example, if the CPE or display device 205 determines that the time of day is 12:00 pm, then the display screen may detect at least one of an amount of ambient light and/or a type of weather condition and may adjust the display setting associated with the time of day being 12:00 pm based on at least one of the amount of ambient light and/or the type of weather condition.

Additionally and/or alternatively, the one or more display settings of the CPE or display device 205 may be adjusted for portions of the display screen 210. Different portions of display screen 210 may be adjusted based on at least one of the amount of ambient light within the room, the time of day, the time of year, or the type of environment within the room, and/or the like. In a first non-limiting example, two or more ambient light sensors may be incorporated in CPE or display device 205. Each sensor may control display settings associated with a different portion of display screen 210. A first sensor may not detect much ambient light, so the portion of the display screen associated with the first sensor may be less bright, while the second sensor may detect a higher amount of ambient light so that the portion of the display screen associated with the second sensor may be brighter. In a second non-limiting example, if window coverings are open, it is sunset, and/or the like, this may affect one portion of the display screen 210, but not a second portion, while the display settings associated with each portion of the display screen 210 may be adjusted accordingly.

FIG. 3 is a schematic diagram illustrating a system 300 for implementing, calibrating, and/or adjusting display settings on one or more display devices and/or on one or more customer premises equipment (“CPEs”) 305.

System 300 includes CPE or display device 305 (which may correspond to CPE 105 or display device 110 of FIG. 1 or CPE or display device 205 of FIG. 2, or the like) with a display screen (not shown in FIG. 3, and which may correspond to display screen 110a of FIG. 1 and/or display screen 210 of FIG. 2, or the like), one or more user devices 310 (which may correspond to user device(s) 115 of FIG. 1, or the like), and one or more sensors 315a and 315b (collectively, “sensors 315” or the like, which may correspond to sensor(s) 120 of FIG. 1 and/or sensor(s) 215 of FIG. 2, or the like). The one or more sensors 315 may be integrated in CPE or display device 305, user device 310, a remote control, a mobile device, a tablet and/or other standalone devices, or the like. Additionally and/or alternatively, the one or more sensors 315 may be pluggable external devices commutatively coupled to CPE or display device 305 and/or user device 310 via a wired and/or wireless (e.g., Bluetooth, WiFi, etc.) connection.

In operation, CPE or display device 305 may be configured to determine one or more optimal display settings automatically. In order to automatically detect one or more optimal display settings, one or more sensors 315a may be used to detect a display screen of CPE or display device 305. These sensors 315a may include one or more cameras, one or more colorimeters, and/or the like. The one or more sensors 315a detecting a display screen may be positioned in a manner to view the entire display screen of CPE or display device 305 or a portion of the display screen and determine one or more optimal display settings (e.g., brightness, contrast, etc.) for a display screen or a portion of the display screen. The display settings of the CPE or display device 305 may then be adjusted based on input from the one or more sensors 315 detecting a display screen.

These adjusted display settings may be adjusted continuously and/or periodically (e.g., every hour, every minute, etc.) based on input from the one or more sensors 315a (e.g., colorimeters, cameras, etc.). Additionally and/or alternatively, the display settings may be adjusted for a portion of the display screen or the entire display screen based on input from one or more sensors 315a. In some embodiments, these adjusted display settings may be automatically associated with at least one of the amount of ambient light within the room, the time of day, the time of year, or the type of environment within the room, and/or the like, and saved in a local or remote storage device(s) for retrieval.

The one or more sensors 315b may then be configured to detect at least one of an amount of ambient light within a room, a time of day, a time of year, a type of environment within the room, or a display screen of the media display device, and/or the like. The one or more sensors 315b might include at least one of one or more ambient light sensors, one or more clocks, one or more window covering sensors (e.g., detecting whether one or more window coverings are opened or closed, or the like), one or more light switch sensors (e.g., detecting whether one or more room lights and/or one or more lamp lights are turned on or off, or the like), one or more weather sensors, one or more colorimeters, or one or more cameras, and/or the like.

The CPE or display device 305 may then adjust the display settings based on the detected at least one of an amount of ambient light within a room, a time of day, a time of year, a type of environment within the room, or a display screen of the media display device, and/or the like. The adjusted display settings may be adjusted based on saved preprogrammed display settings, saved user configured display settings, and/or saved optimal display settings determined from the one or more sensors 315a (e.g., cameras, colorimeters, etc.) detecting the display screen.

In order to adjust CPE or display device 305 based on a sensor 315 incorporated within user device 310, a remote control, a mobile device, a tablet, and/or other standalone devices, and/or the like (collectively, “a media display device” or the like), CPE or display device 305 might detect whether user device 310, a remote control, a mobile device, a tablet, and/or other standalone devices, and/or the like (collectively, “a media display device” or the like), is in the same room as CPE or display device 305. Based on a determination that user device 310, a remote control, a mobile device, a tablet, and/or other standalone devices, and/or the like (collectively, “a media display device” or the like) is in the same room as CPE or display device 305, CPE or display device 305 might adjust one or more display settings based on input from user device 310, a remote control, a mobile device, a tablet, and/or other standalone devices, and/or the like (collectively, “a media display device” or the like).

In some embodiments, with respect to the amount of ambient light within a room, the one or more ambient light sensors may be incorporated within CPE or display device 305, user device 310, and/or the like. The ambient light sensors may detect an amount of ambient light within a room, and at least one of the CPE or display device 305 and/or user device 310 might adjust the display settings of a display screen of CPE or display device 305.

In some cases, with respect to a time of day or a time of year, CPE or display device 305 and/or user device 310 may determine at least one of a time of day or a time of year and may adjust one or more display settings based on the time of day or the time of year.

In some instances, with respect to a type of environment, one or more window covering sensors (e.g., detecting whether one or more window coverings are opened or closed, or the like), one or more light switch sensors (e.g., detecting whether one or more room lights and/or one or more lamp lights are turned on or off, or the like), one or more weather sensors, and/or the like may detect a type of environment within a room. Additionally and/or alternatively, CPE or display device 305 and/or user device 310 may access weather reports online via one or more network to determine a type of weather. At least one of the CPE or display device 305 and/or user device 310 might adjust the display settings of a display screen of CPE or display device 305 based on the detected environment.

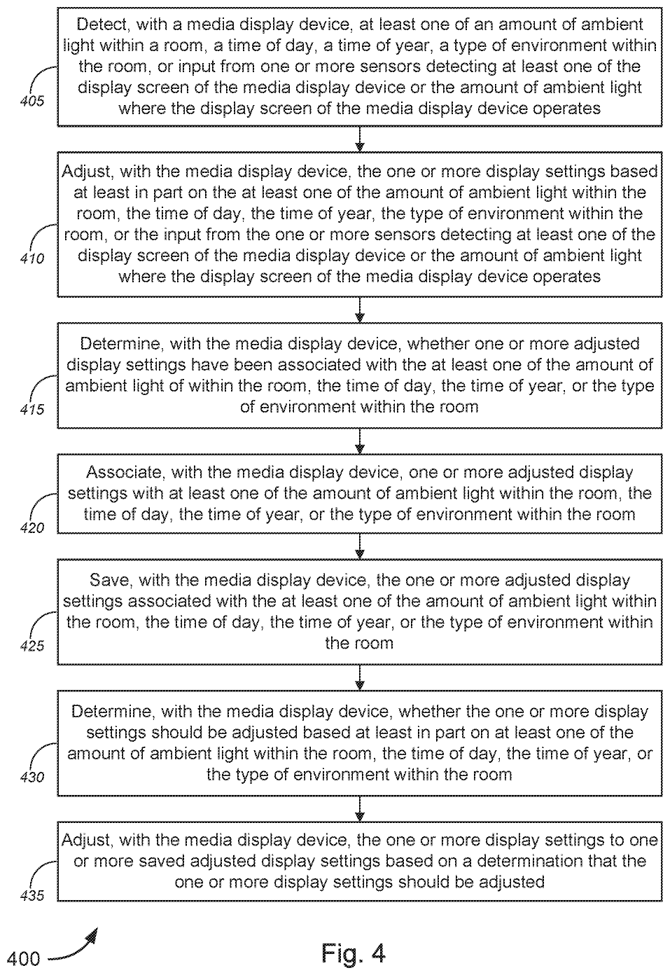

FIG. 4 is a flow diagram illustrating a method 400 for implementing, calibrating, and/or adjusting display settings on one or more display devices and/or on one or more customer premises equipment, in accordance with various embodiments.

While the techniques and procedures are depicted and/or described in a certain order for purposes of illustration, it should be appreciated that certain procedures may be reordered and/or omitted within the scope of various embodiments. Moreover, while the method 400 illustrated by FIG. 4 can be implemented by or with (and, in some cases, are described below with respect to) the systems 100, 200, and 300 of FIGS. 1, 2, and 3, respectively (or components thereof), such methods may also be implemented using any suitable hardware (or software) implementation. Similarly, while each of the systems 100, 200, and 300 of FIGS. 1, 2, and 3, respectively (or components thereof), can operate according to the method 400 illustrated by FIG. 4 (e.g., by executing instructions embodied on a computer readable medium), the systems 100, 200, and 300 of FIGS. 1, 2, and 3, respectively, can each also operate according to other modes of operation and/or perform other suitable procedures.

In the non-limiting embodiment of FIG. 4, method 400, at block 405, might comprise detecting, with a media display device, a remote control, a mobile device, a tablet, and/or other standalone devices, and/or the like (collectively, “a media display device” or the like), at least one of an amount of ambient light within a room, a time of day, a time of year, a type of environment within the room, or input from one or more sensors detecting at least one of the display screen of the media display device or the ambient light level where the display screen of the media display device operates, and/or the like. The media display device may be at least one of a television, a laptop computer, a tablet computer, a smart phone, or a mobile phone, and/or the like.

The method 400, at block 410, might continue with adjusting, with the media display device, the one or more display settings based at least in part on the at least one of the amount of ambient light within the room, the time of day, the time of year, the type of environment within the room, or the input from the one or more sensors detecting at least one of the display screen of the media display device or the ambient light level where the display screen of the media display device operates, and/or the like. The one or more display settings might include, without limitation, one or more brightness settings, one or more color settings, or one or more contrast settings, and/or the like.

In various embodiments, the ambient light within the room may be detected using an ambient light sensor. The ambient light sensor may be incorporated in at least one of the media display device, a set-top box, or a user device, and/or the like.

The type of environment within a room may include at least one of a position of one or more curtains within the room, a number of lights turned on within the room, or a type of weather occurring outside the room, and/or the like. The type of environment may be detected by at least one of one or more window covering sensors (e.g., detecting whether one or more window coverings are opened or closed, or the like), one or more light switch sensors (e.g., detecting whether one or more room lights and/or one or more lamp lights are turned on or off, or the like), one or more weather sensors, one or more ambient light sensors, and/or the like.

The one or more sensors detecting the display screen and/or detecting the ambient light level where the display screen of the media display device operates of the media display device may include one or more colorimeter sensors or one or more cameras. The media display device may determine one or more display settings to adjust, based at least in part on input from the one or more colorimeter sensors or the one or more cameras. The one or more colorimeter sensors and/or one or more cameras may provide input to the media display device regarding one or more display settings to adjust.

The method 400, at block 415, may additionally include determining, with the media display device, whether one or more adjusted display settings have been associated with the at least one of the amount of ambient light within the room, the time of day, the time of year, or the type of environment within the room, and/or the like. Based on a determination that the one or more adjusted display settings have been associated with the at least one of the amount of ambient light within the room, the time of day, the time of year, or the type of environment within the room, the method might include adjusting, with the media display device, the one or more display settings based at least in part on the at least one of the amount of ambient light within the room, the time of day, the time of year, or the type of environment within the room, and/or the like.

Based on a determination that the one or more adjusted display settings have not been associated with the at least one of the amount of ambient light within the room, the time of day, the time of year, or the type of environment within the room, the method might include prompting a user to set one or more display settings associated with at least one of the amount of ambient light within the room, the time of day, the time of year, or the type of environment within the room, and/or the like. Alternatively, the method 400 may use input from one or more colorimeters and/or one or more cameras to determine one or more optimal settings associated with at least one of the amount of ambient light within the room, the time of day, the time of year, or the type of environment within the room, and/or the like.

Additionally, based on a determination that the one or more adjusted display settings have not been associated with the at least one of the amount of ambient light within the room, the time of day, the time of year, or the type of environment within the room, the method 400, at block 420, might associate, with the media display device, one or more adjusted display settings (e.g., adjusted based on user input and/or adjusted based on input from the one or more colorimeter sensors or cameras) with at least one of the amount of ambient light within the room, the time of day, the time of year, or the type of environment within the room, and/or the like and might save, with the media display device, the one or more adjusted display settings associated with the at least one of the amount of ambient light within the room, the time of day, the time of year, or the type of environment within the room, and/or the like (block 425).

In some cases, the method 400, at block 430, may then comprise determining, with the media display device, whether the one or more display settings should be adjusted based at least in part on at least one of the amount of ambient light within the room, the time of day, the time of year, or the type of environment within the room, and/or the like, and adjusting, with the media display device, the one or more display settings to one or more saved adjusted display settings based on a determination that the one or more display settings should be adjusted (block 435).

### Exemplary System and Hardware Implementation

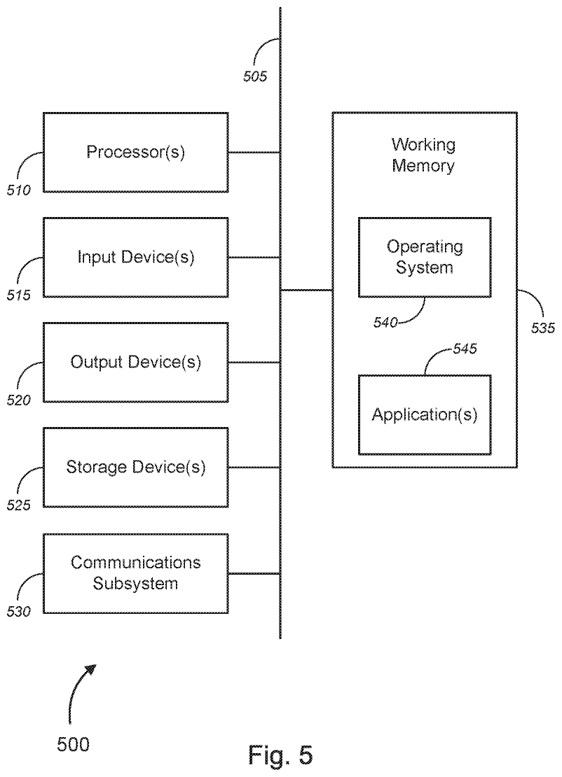

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., customer premises equipment 105, 205, and 305, display devices 110, 205, and 305, user devices 115 and 310, one or more sensors 120, 215, and 315, local storage device(s) 125, and remote storage device(s) 130, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500—which might represent an embodiment of the computer or hardware system (i.e., customer premises equipment 105, 205, and 305, display devices 110, 205, and 305, user devices 115 and 310, one or more sensors 120, 215, and 315, local storage device(s) 125, and remote storage device(s) 130, etc.), described above with respect to FIGS. 1-4—is shown comprising hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard and/or the like; and one or more output devices 520, which can include, without limitation, a display device, a printer, and/or the like.

The computer or hardware system 500 may further include (and/or be in communication with) one or more storage devices 525, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. In some aspects, the communications subsystem 530 might also comprise a wireless video link system, which might utilize a wireless video link protocol comprising at least one of WirelessHD protocol, Wireless Home Digital Interface (“WHDI”) protocol, or Wireless Gigabit Alliance (“WiGig”) protocol, and/or the like. The communications subsystem 530 may permit data to be exchanged with a network (such as the network described below, to name one example), with other computer or hardware systems, and/or with any other devices described herein. In many embodiments, the computer or hardware system 500 will further comprise a working memory 535, which can include a RAM or ROM device, as described above.

The computer or hardware system 500 also may comprise software elements, shown as being currently located within the working memory 535, including an operating system 540, device drivers, executable libraries, and/or other code, such as one or more application programs 545, which may comprise computer programs provided by various embodiments (including, without limitation, hypervisors, VMs, and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated in the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire and fiber optics, including the wires that comprise the bus 505, as well as the various components of the communication subsystem 530 (and/or the media by which the communications subsystem 530 provides communication with other devices). In an alternative set of embodiments, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

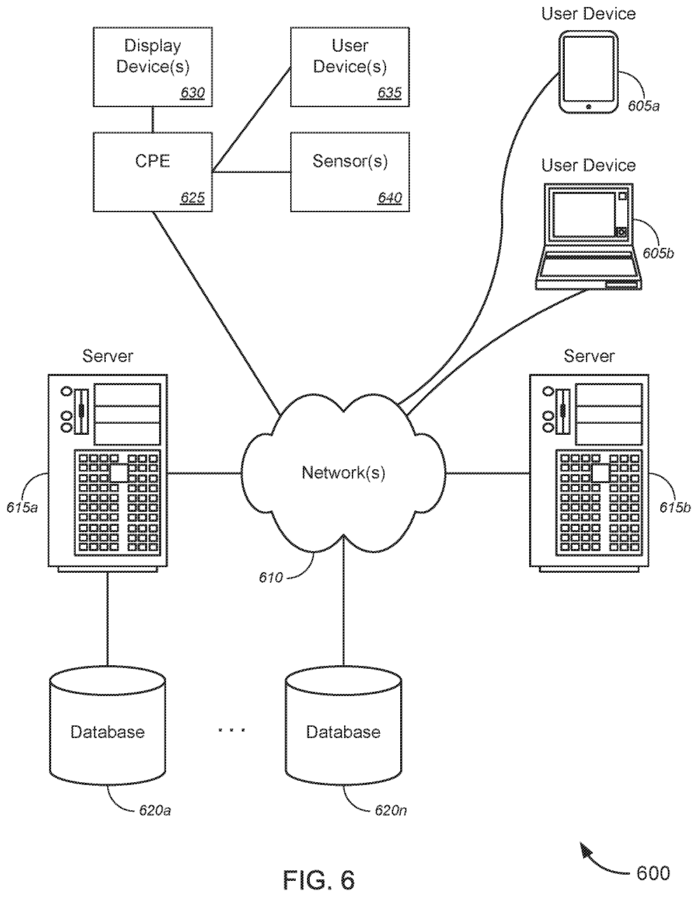

As noted above, a set of embodiments comprises methods and systems for implementing display settings on customer premises equipment (“CPE”), and, more particularly, to methods, systems, and apparatuses for implementing, calibrating, and/or adjusting display settings one or more display devices and/or on one or more CPEs. FIG. 6 illustrates a schematic diagram of a system 600 that can be used in accordance with one set of embodiments. The system 600 can include one or more user computers, user devices, or customer devices 605. A user computer, user device, or customer device 605 can be a general purpose personal computer (including, merely by way of example, desktop computers, tablet computers, laptop computers, handheld computers, and the like, running any appropriate operating system, several of which are available from vendors such as Apple, Microsoft Corp., and the like), cloud computing devices, a server(s), and/or a workstation computer(s) running any of a variety of commercially-available UNIX™ or UNIX-like operating systems. A user computer, user device, or customer device 605 can also have any of a variety of applications, including one or more applications configured to perform methods provided by various embodiments (as described above, for example), as well as one or more office applications, database client and/or server applications, and/or web browser applications. Alternatively, a user computer, user device, or customer device 605 can be any other electronic device, such as a thin-client computer, Internet-enabled mobile telephone, and/or personal digital assistant, capable of communicating via a network (e.g., the network(s) 610 described below) and/or of displaying and navigating web pages or other types of electronic documents. Although the exemplary system 600 is shown with two user computers, user devices, or customer devices 605, any number of user computers, user devices, or customer devices can be supported.

Certain embodiments operate in a networked environment, which can include a network(s) 610. The network(s) 610 can be any type of network familiar to those skilled in the art that can support data communications using any of a variety of commercially-available (and/or free or proprietary) protocols, including, without limitation, TCP/IP, SNA™, IPX™, AppleTalk™, and the like. Merely by way of example, the network(s) 610 (similar to network(s) 135 of FIG. 1, or the like) can each include a local area network (“LAN”), including, without limitation, a fiber network, an Ethernet network, a Token-Ring™ network and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network might include an access network of the service provider (e.g., an Internet service provider (“ISP”)). In another embodiment, the network might include a core network of the service provider, and/or the Internet.

Embodiments can also include one or more server computers 615. Each of the server computers 615 may be configured with an operating system, including, without limitation, any of those discussed above, as well as any commercially (or freely) available server operating systems. Each of the servers 615 may also be running one or more applications, which can be configured to provide services to one or more clients 605 and/or other servers 615.

Merely by way of example, one of the servers 615 might be a data server, a web server, a cloud computing device(s), or the like, as described above. The data server might include (or be in communication with) a web server, which can be used, merely by way of example, to process requests for web pages or other electronic documents from user computers 605. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 605 to perform methods of the invention.

The server computers 615, in some embodiments, might include one or more application servers, which can be configured with one or more applications accessible by a client running on one or more of the client computers 605 and/or other servers 615. Merely by way of example, the server(s) 615 can be one or more general purpose computers capable of executing programs or scripts in response to the user computers 605 and/or other servers 615, including, without limitation, web applications (which might, in some cases, be configured to perform methods provided by various embodiments). Merely by way of example, a web application can be implemented as one or more scripts or programs written in any suitable programming language, such as Java™, C, C #™ or C++, and/or any scripting language, such as Perl, Python, or TCL, as well as combinations of any programming and/or scripting languages. The application server(s) can also include database servers, including, without limitation, those commercially available from Oracle™, Microsoft™, Sybase™, IBM™, and the like, which can process requests from clients (including, depending on the configuration, dedicated database clients, API clients, web browsers, etc.) running on a user computer, user device, or customer device 605 and/or another server 615. In some embodiments, an application server can perform one or more of the processes for implementing display settings on customer premises equipment (“CPE”), and, more particularly, to methods, systems, and apparatuses for implementing, calibrating, and/or adjusting display settings on one or more display devices and/or on one or more CPEs, as described in detail above. Data provided by an application server may be formatted as one or more web pages (comprising HTML, JavaScript, etc., for example) and/or may be forwarded to a user computer 605 via a web server (as described above, for example). Similarly, a web server might receive web page requests and/or input data from a user computer 605 and/or forward the web page requests and/or input data to an application server. In some cases, a web server may be integrated with an application server.

In accordance with further embodiments, one or more servers 615 can function as a file server and/or can include one or more of the files (e.g., application code, data files, etc.) necessary to implement various disclosed methods, incorporated by an application running on a user computer 605 and/or another server 615. Alternatively, as those skilled in the art will appreciate, a file server can include all necessary files, allowing such an application to be invoked remotely by a user computer, user device, or customer device 605 and/or server 615.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 620a-620n (collectively, “databases 620”). The location of each of the databases 620 is discretionary: merely by way of example, a database 620a might reside on a storage medium local to (and/or resident in) a server 615a (and/or a user computer, user device, or customer device 605). Alternatively, a database 620n can be remote from any or all of the computers 605, 615, so long as it can be in communication (e.g., via the network 610) with one or more of these. In a particular set of embodiments, a database 620 can reside in a storage-area network (“SAN”) familiar to those skilled in the art. (Likewise, any necessary files for performing the functions attributed to the computers 605, 615 can be stored locally on the respective computer and/or remotely, as appropriate.) In one set of embodiments, the database 620 can be a relational database, such as an Oracle database, that is adapted to store, update, and retrieve data in response to SQL-formatted commands. The database might be controlled and/or maintained by a database server, as described above, for example.

According to some embodiments, system 600 might further comprise customer premises equipment (“CPE”) 625 (similar to customer premises equipment 105, 205, and 305, of FIGS. 1-3, etc.), one or more display devices 630 (similar to display devices 110, 205, and 305 of FIGS. 1-3 and corresponding display screens 110a and 210 of FIGS. 1 and 2, etc.), one or more user devices 635 (similar to user devices 115 and 310 of FIGS. 1 and 3, etc.), one or more sensors (similar to one or more sensors 120, 215, and 315 of FIGS. 1-3, etc.), and/or the like.

In operation, the CPE 625, display device 630, the user device 635, the and/or the one or more sensors 640 might detect at least one of an amount of ambient light within a room, a time of day, a time of year, a type of environment within the room, input from one or more sensors detecting a display screen of the display device 630 or of the CPE 625, or input from one or more sensors 640 detecting a type of environment within the room. The CPE 625 and/or display device 630 might then adjust one or more display settings based at least in part on the at least one of the amount of ambient light within the room, the time of day, the time of year, the type of environment within the room, or the input from the one or more sensors detecting the display screen of the display device 630 or of the CPE 625.

These and other functions of the system 600 (and its components) are described in greater detail above with respect to FIGS. 1-4.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

1. A method, comprising:
detecting, with a media display device, at least one of an amount of ambient light within a room, a time of day, a time of year, a type of environment within the room, or input from one or more sensors detecting at least one of the display screen of the media display device or an amount of ambient light where the display screen of the media display device operates; and
adjusting, with the media display device, one or more display settings for a first portion of the display screen of the display device based at least in part on the at least one of the amount of ambient light within the room, the time of day, the time of year, the type of environment within the room, or the input from the one or more sensors detecting at least one of the display screen of the media display device or the amount of ambient light where the display screen of the media display device operates, wherein the first portion of the display screen is less than the entire display screen.

2. The method of claim 1, wherein the media display device is at least one of a television, a laptop computer, a tablet computer, a smart phone, or a mobile phone.

3. The method of claim 1, wherein the one or more display settings comprise one or more brightness settings, one or more color settings, or one or more contrast settings.

4. The method of claim 1, wherein the ambient light within the room is detected using an ambient light sensor.

5. The method of claim 4, wherein the ambient light sensor is incorporated in at least one of the media display device, a set-top box, or a user device.

6. The method of claim 1, wherein the type of environment within the room includes at least one of a position of one or more curtains within the room, a number of lights turned on within the room, or a type of weather occurring outside the room.

7. The method of claim 1, wherein the one or more sensors detecting at least one of the display screen of the media display device or the amount of ambient light where the display screen of the media display device operates comprise one or more colorimeter sensors or one or more cameras.

8. The method of claim 7, wherein the media display device determines one or more display settings to adjust, based at least in part on input from the one or more colorimeter sensors or the one or more cameras.

9. The method of claim 1, further comprising:
associating, with the media display device, one or more adjusted display settings with at least one of the amount of ambient light within the room, the time of day, the time of year, or the type of environment within the room; and
saving, with the media display device, the one or more adjusted display settings associated with the at least one of the amount of ambient light within the room, the time of day, the time of year, or the type of environment within the room.

10. The method of claim 9, further comprising:
determining, with the media display device, whether the one or more display settings should be adjusted based at least in part on at least one of the amount of ambient light within the room, the time of day, the time of year, or the type of environment within the room; and
adjusting, with the media display device, the one or more display settings to one or more saved adjusted display settings based on a determination that the one or more display settings should be adjusted.

11. The method of claim 1, wherein the one or more display settings are configured by a user of the media display device.

12. The method of claim 1, further comprising:
prompting a user to set one or more display settings associated with at least one of the amount of ambient light within the room, the time of day, the time of year, or the type of environment within the room.

13. The method of claim 1, further comprising:
determining, with the media display device, whether one or more adjusted display settings have been associated with the at least one of the amount of ambient light within the room, the time of day, the time of year, or the type of environment within the room;
based on a determination that the one or more adjusted display settings have been associated with the at least one of the amount of ambient light within the room, the time of day, the time of year, or the type of environment within the room, adjusting, with the media display device, the one or more display settings based at least in part on the at least one of the amount of ambient light within the room, the time of day, the time of year, or the type of environment within the room; and
based on a determination that the one or more adjusted display settings have not been associated with the at least one of the amount of ambient light within the room, the time of day, the time of year, or the type of environment within the room, prompting a user to set one or more display settings associated with at least one of the amount of ambient light within the room, the time of day, the time of year, or the type of environment within the room.

14. An apparatus, comprising:
at least one processor; and
a non-transitory computer readable medium communicatively coupled to the at least one processor, the non-transitory computer readable medium having stored thereon computer software comprising a set of instructions that, when executed by the at least one processor, causes the apparatus to:
detect at least one of an amount of ambient light within a room, a time of day, a time of year, a type of environment within the room, or input from one or more sensors detecting at least one of a display screen of a media display device or the amount of ambient light where the display screen of the media display device operates; and
adjust one or more display settings for a first portion of the display screen of the display device based at least in part on the at least one of the amount of ambient light within the room, the time of day, the time of year, the type of environment within the room, or the input from the one or more sensors detecting at least one of the display screen of the media display device or the amount of ambient light where the display screen of the media display device operates, wherein the first portion of the display screen is less than the entire display screen.

15. The apparatus of claim 14, wherein the one or more display settings comprise one or more brightness settings, one or more color settings, or one or more contrast settings.

16. The apparatus of claim 14, wherein the ambient light within the room is detected using an ambient light sensor.

17. The apparatus of claim 14, wherein the type of environment within the room includes at least one of a position of one or more curtains within the room, a number of lights turned on within the room, or a type of weather occurring outside the room.

18. The apparatus of claim 14, wherein the one or more sensors detecting at least one of the display screen of the media display device or the amount of ambient light where the display screen of the media display device operates comprise one or more colorimeter sensors.

19. A system comprising:
a first display device, comprising:
at least one first processor; and
a first non-transitory computer readable medium communicatively coupled to the at least one first processor, the first non-transitory computer readable medium having stored thereon computer software comprising a first set of instructions that, when executed by the at least one first processor, causes the first display device to:
detect at least one of an amount of ambient light within a room, a time of day, a time of year, a type of environment within the room, or input from one or more sensors detecting at least one of the display screen of the media display device or the amount of ambient light where the display screen of the media display device operates; and
adjust one or more display settings for a first portion of the display screen of the display device based at least in part on the at least one of the amount of ambient light within the room, the time of day, the time of year, the type of environment within the room, or the input from the one or more sensors detecting at least one of the display screen of the media display device or the amount of ambient light where the display screen of the media display device operates, wherein the first portion of the display screen is less than the entire display screen.

20. The system of claim 19, further comprising:
one or more sensors, comprising:
at least one second processor; and
a second non-transitory computer readable medium communicatively coupled to the at least one second processor, the second non-transitory computer readable medium having stored thereon computer software comprising a second set of instructions that, when executed by the at least one second processor, causes the one or more sensors to:
detect at least one of the amount of ambient light within the room, the type of environment within the room, or the display screen of the media display device; and
send information associated with at least one of the amount of ambient light within the room, the type of environment within the room, or the display screen of the media display device to the media display device.
